(19) United States
(12) Patent Application Publication
(10) Pub. No.: US 2022/0059934 A1
(43) Pub. Date: Feb. 24, 2022

(54) TRANSMISSION UNIT FOR PHASE SHIFTER OF BASE STATION ANTENNA

(71) Applicant: CommScope Technologies LLC, Hickory, NC (US)

(72) Inventor: Bin Ai, Suzhou (CN)

(21) Appl. No.: 17/389,880

(22) Filed: Jul. 30, 2021

(30) Foreign Application Priority Data
Aug. 20, 2020 (CN) 202010840601.9

(51) Int. Cl. H01Q 3/32; H01Q 1/24; H01Q 1/12

(52) U.S. Cl. CPC H01Q 3/32; H01Q 1/125; H01Q 1/246

(57) ABSTRACT

The present invention relates to a transmission unit for a phase shifter of a base station antenna. The transmission unit includes a gear set, a driving connecting rod configured to be coupled with a drive unit, a controlling connecting rod configured to control the phase shifter, and a scale connecting rod configured to be mounted with a scale, wherein the driving connecting rod, the controlling connecting rod, and the scale connecting rod are respectively meshed with the gear set, and the controlling connecting rod is in transmission connection with the scale connecting rod through the gear set with a first transmission ratio less than 1. In this way, the display of the electrical downtilt angle of the phase shifter by use of the scale can be improved by simple measures.

### RELATED APPLICATION

The present application claims priority from and the benefit of Chinese Application No. 202010840601.9, filed Aug. 20, 2020, the disclosure of which is hereby incorporated herein by reference in full.

### FIELD OF THE INVENTION

The present invention relates to the field of base station antennas, and more specifically, to a transmission unit for a phase shifter of a base station antenna.

### BACKGROUND OF THE INVENTION

With the development of mobile communication technology, especially in the 5G era, there is a trend of miniaturization of base station antennas. Correspondingly, radiators or elements of base station antennas will also be miniaturized. A phase shifter matched with the radiator can be used to adjust the electrical downtilt angle of the related radiator, so that the related radiator array can have a radiation cone oriented at a desired angle. With the miniaturization of the phase shifter, the stroke of the phase shifter corresponding to each degree of electrical downtilt angle can be reduced accordingly. It is even possible in some cases that the systematic cumulative error of a transmission chain from a drive unit of the phase shifter to a rocker arm of the phase shifter has reached an order of magnitude corresponding to one degree of electrical downtilt angle. This may make it difficult to accurately adjust the electrical downtilt angle and accurately display it through a scale. In addition, calibrations on the scale corresponding to the electrical downtilt angle may be too dense to be easily discerned.

### SUMMARY OF THE INVENTION

An objective of the present invention is to provide a transmission unit for a phase shifter of a base station antenna so that the display of the electrical downtilt angle by the scale can be improved.

To this end, a transmission unit for a phase shifter of a base station antenna is proposed, wherein the transmission unit includes a gear set, a driving connecting rod configured to be coupled with a drive unit, a controlling connecting rod configured to control the phase shifter, and a scale connecting rod configured to be mounted with a scale, wherein the driving connecting rod, the controlling connecting rod, and the scale connecting rod are respectively meshed with the gear set, and the controlling connecting rod is in transmission connection with the scale connecting rod through the gear set with a first transmission ratio less than 1.

Through gearing-up between the controlling connecting rod and the scale connecting rod, the scale spacing of the scale can be magnified by a multiple, which is a reciprocal of the first transmission ratio. For example, when the first transmission ratio is 1/2, the spacing of the scale can be enlarged by 2 times. As a result, the accuracy of the electrical downtilt angle displayed by the scale can be increased by 2 times, and the influence of the systematic cumulative error on the display accuracy of the electrical downtilt angle of the scale can be reduced by half.

In some embodiments, the driving connecting rod and the controlling connecting rod may be the same connecting rod.

In some embodiments, the driving connecting rod and the controlling connecting rod may be two separate connecting rods.

In some embodiments, the driving connecting rod and the controlling connecting rod may be in transmission connection with the scale connecting rod through the gear set with a second transmission ratio greater than 1.

In some embodiments, the reciprocal of the first transmission ratio may be at least 1.25, for example, 2 to 3.

In some embodiments, the second transmission ratio may be at least 1.25, for example, 2 to 3.

In some embodiments, the second transmission ratio may be a reciprocal of the first transmission ratio.

In some embodiments, at least two of the driving connecting rod, the controlling connecting rod, and the scale connecting rod may be guided in parallel to each other. For example, the three may be guided in parallel to each other.

In some embodiments, the gear set may include a first gear and a second gear, the first gear has a diameter smaller than that of the second gear, the controlling connecting rod may be meshed with the first gear, and the scale connecting rod may be meshed with the second gear.

In some embodiments, the first gear and the second gear may be coaxially and non-rotatably connected with each other.

In some embodiments, the driving connecting rod may be meshed with the second gear.

In some embodiments, with reference to the common axis of rotation of the first gear and the second gear, the driving connecting rod and the controlling connecting rod may be on one side, and the scale connecting rod may be on the other side.

In some embodiments, the gear set may further include a first additional gear, the axis of rotation of the first additional gear is in parallel with and spaced apart from the axis of rotation of the first gear, the controlling connecting rod is further meshed with the first additional gear so that the controlling connecting rod is linearly guided by the first gear and the first additional gear.

In some embodiments, the first additional gear may have a diameter the same as that of the first gear.

In some embodiments, the gear set may further include a second additional gear, the axis of rotation of the second additional gear is in parallel with and spaced apart from the axis of rotation of the second gear, the scale connecting rod is further meshed with the second additional gear so that the scale connecting rod is linearly guided by the second gear and the second additional gear.

In some embodiments, the second additional gear may have a diameter the same as that of the second gear.

In some embodiments, the driving connecting rod may be meshed with the second gear and with the second additional gear so that the driving connecting rod is linearly guided by the second gear and the second additional gear.

In some embodiments, the transmission unit may include a housing, and shafts of each gear of the gear set are supported in the housing.

### BRIEF DESCRIPTION OF THE DRAWINGS

The present invention will be described in more detail below by embodiments with reference to the attached drawings, wherein:

FIG. 1 is a perspective view of a transmission unit for a phase shifter of a base station antenna according to an embodiment of the present invention.

FIG. 2 is a partially enlarged exploded perspective view of the transmission unit of FIG. 1.

FIG. 3 is a partially enlarged top view of the transmission unit of FIG. 1.

FIG. 4 is a top view of a transmission unit according to another embodiment of the present invention.

### DESCRIPTION OF THE EMBODIMENTS

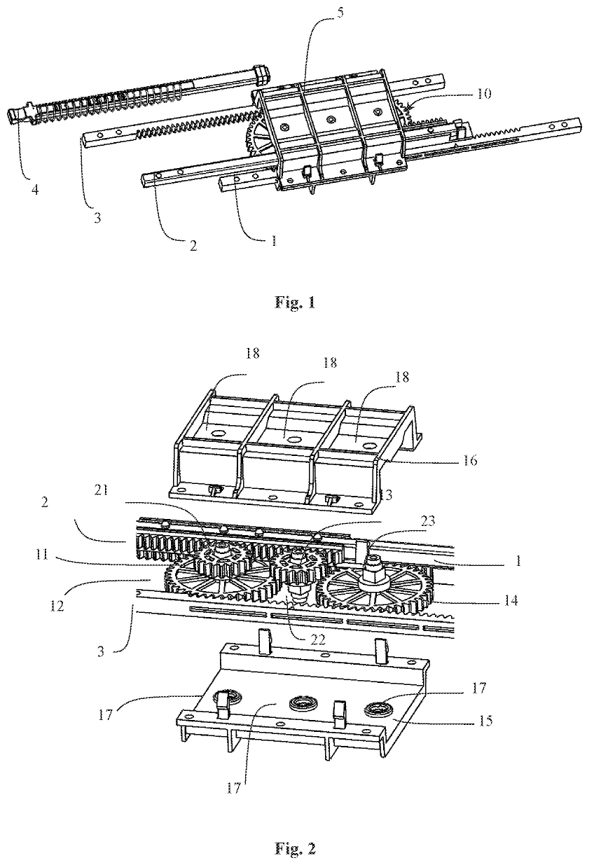

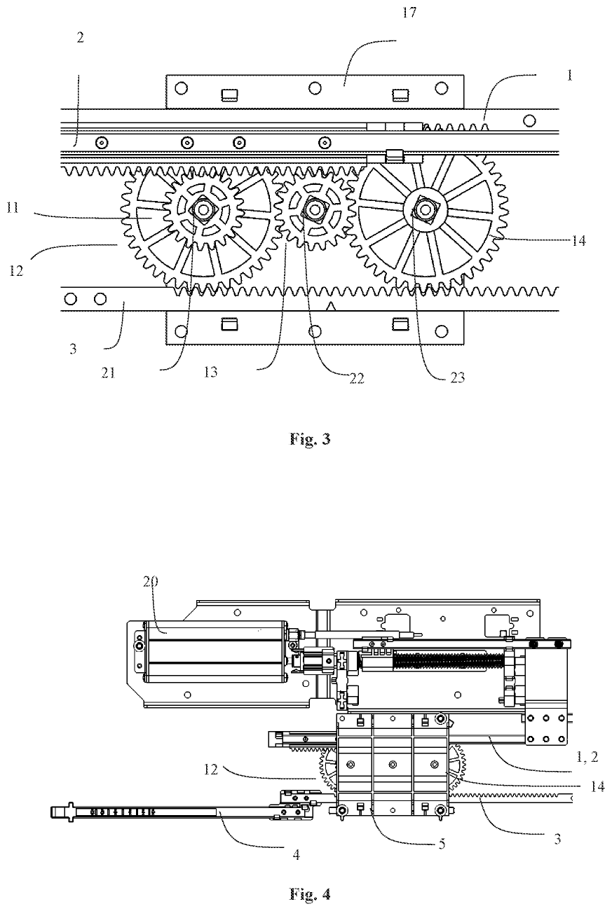

Hereinafter, description will be made to a transmission unit for a phase shifter of a base station antenna according to an embodiment of the present invention with reference to FIG. 1 to FIG. 3, wherein FIG. 1 is a perspective view of the transmission unit and additionally schematically depicts a scale, FIG. 2 is a partially enlarged exploded perspective view of the transmission unit, and FIG. 3 is a top view of the transmission unit, in which a housing component of a housing is omitted so that a gear set in the housing can be observed.

In the embodiment shown in FIG. 1 to FIG. 3, there are three separate connecting rods, i.e., a driving connecting rod 1 configured to be coupled with a drive unit, a controlling connecting rod 2 configured to control a phase shifter, and a scale connecting rod 3 configured to be mounted with a scale 4. The driving connecting rod 1, the controlling connecting rod 2, and the scale connecting rod 3 can be guided in parallel to each other. Regarding the drive unit itself, for example, reference may be made to the embodiment shown in FIG. 4, in which a drive unit 20 is described. The drive unit may include an electric motor and a bolt-nut mechanism driven by the electric motor, and the nut of the bolt-nut mechanism may be directly or indirectly coupled with the driving connecting rod 1 so as to linearly movably drive the driving connecting rod 1.

The transmission unit may include a gear set 10. The driving connecting rod 1, the controlling connecting rod 2, and the scale connecting rod 3 may be respectively meshed with the gear set 10, wherein the driving connecting rod 1 may be used as an input end of the transmission unit, and the controlling connecting rod 2 and the scale connecting rod 3 may be respectively used as output ends of the transmission unit. The controlling connecting rod 2 may be in transmission connection with the scale connecting rod 3 through the gear set 10 with a first transmission ratio less than 1. Therefore, a smaller displacement of the controlling connecting rod 2 can be converted into a larger displacement of the scale connecting rod 3, and as a result, each degree of the electrical downtilt angle of the phase shifter can correspond to a larger stroke of the scale connecting rod 3. The scale mounted on the scale connecting rod 3 may have a stroke equal to the stroke of the scale connecting rod 3, so that each degree of the electrical downtilt angle of the phase shifter can correspond to a larger scale spacing of the scale. This can improve the accuracy of the display of the scale and reduce the influence of the systematic cumulative error on the scale reading.

In the embodiment shown in FIG. 1 to FIG. 3, the gear set 10 may include a first gear 11 and a second gear 12, and the diameter of the first gear 11 may be half of the diameter of the second gear 12. The first gear 11 and the second gear 12 may be coaxially and non-rotatably connected with each other. The gear set 10 may further include a first additional gear 13 and a second additional gear 14. The first additional gear 13 may have a diameter the same as the diameter of the first gear 11, and the axis of rotation of the first additional gear 13 may be in parallel with and spaced apart from the axis of rotation of the first gear. The second additional gear 14 may have a diameter the same as the diameter of the second gear 12, and the axis of rotation of the second additional gear 14 may be in parallel with and spaced apart from the axis of rotation of the second gear 12.

The driving connecting rod 1 may be meshed with the second gear 12 and the second additional gear 14. It can be understood that the second additional gear 14 is an optional element. When the second additional gear 14 is additionally provided, the meshing of the driving connecting rod 1 with the gear set 10 and the guiding of the driving connecting rod 1 can be facilitated. The controlling connecting rod 2 may be meshed with the first gear 11 and the first additional gear 13. It can be understood that the first additional gear 13 is also an optional element. When the first additional gear 13 is additionally provided, the meshing of the controlling connecting rod 2 with the gear set 10 and the guiding of the controlling connecting rod 1 can be facilitated. The scale connecting rod 3 may be meshed with the second gear 12 and the second additional gear 14. With reference to the common axis of rotation of the first gear and the second gear, the driving connecting rod 1 and the controlling connecting rod 2 may be on one side, and the scale connecting rod 3 may be on the other side.

In the embodiment shown in FIG. 1 to FIG. 3, the driving connecting rod 1 and the controlling connecting rod 2 are in transmission connection through the gear set 10 with a transmission ratio of 2. Therefore, a larger stroke of the drive unit can be converted into a smaller stroke of the phase shifter (which is not shown), wherein the stroke of the driving connecting rod 1 can cause half of the stroke of the controlling connecting rod 2. This can significantly reduce the negative influence of the systematic cumulative error on the adjustment accuracy of the phase shifter. The controlling connecting rod 2 and the scale connecting rod 3 are in transmission connection through the gear set 10 with a transmission ratio of 1/2 (or a speed increasing ratio of 2). Therefore, a smaller stroke of the phase shifter which is not shown can be converted into a larger stroke of the scale 4, wherein the stroke of the controlling connecting rod 2 can cause twice the stroke of the scale connecting rod 3. This can double the scale spacing of the scale corresponding to each degree of electrical downtilt angle, and can significantly reduce the negative influence of the systematic cumulative error on the display accuracy of the scale. The first transmission ratio of the controlling connecting rod 2 and the scale connecting rod 3 may be, for example, 1/2 to 1/3. The second transmission ratio of the driving connecting rod 1 and the controlling connecting rod 2 may be, for example, 2 to 3.

The transmission unit may include a housing 5, and shafts 21, 22, and 23 of each gear of the gear set may be supported in the housing. The housing 5 may be configured in two parts, including two housing parts 15 and 16. Each housing part may have a set of supporting holes 17 and 18, and the shafts 21, 22, and 23 are respectively supported by one of the supporting holes 17 and 18 with the end portions of the shafts in the supporting holes.

As can be seen from FIG. 2, the first gear 11 and the first additional gear 13 may be on a first level, and the second gear 12 and the second additional gear 14 may be on a second level. It may be considered that a third level is provided, and at least one additional gear is provided on the third level, so that a more pronounced input and output combination of the gear set 10 can be achieved. In addition, it is also possible that two first additional gears 13 with the same diameter may be provided on the first level, and the controlling connecting rod may be meshed with the first gear and the two first additional gears.

FIG. 4 is a top view of a transmission unit according to another embodiment of the present invention. This embodiment differs from the embodiment of FIG. 1 mainly in that the driving connecting rod 1 and the controlling connecting rod 2 are the same connecting rod, the connecting rod is meshed with the first gear 11 and the first additional gear 13, and the scale connecting rod 3 is meshed with the second gear 12 and the second additional gear 14. In this embodiment, the gear set 10 may be configured in the same manner as in the embodiment as described in FIG. 1 to FIG. 3. For the gear set 10, reference may be made to the description of the previous embodiment. FIG. 4 further shows a drive unit 20, which includes a driving motor and a screw-nut mechanism driven by the driving motor, and the nut of the screw-nut mechanism is sleeved on a screw rod and movably supported. The driving connecting rod 1 or the controlling connecting rod 2 is connected with the nut of the screw-nut mechanism.

It will be understood that, the terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprise” and “include” (and variants thereof), when used in this specification, specify the presence of stated operations, elements, and/or components, but do not preclude the presence or addition of one or more other operations, elements, components, and/or groups thereof. As used herein, the term “and/or” includes any and all combinations of one or more of the associated listed items. Like reference numbers signify like elements throughout the description of the figures.

The thicknesses of elements in the drawings may be exaggerated for the sake of clarity. Further, it will be understood that when an element is referred to as being “on,” “coupled to” or “connected to” another element, the element may be formed directly on, coupled to or connected to the other element, or there may be one or more intervening elements therebetween. In contrast, terms such as “directly on,” “directly coupled to” and “directly connected to,” when used herein, indicate that no intervening elements are present. Other words used to describe the relationship between elements should be interpreted in a like fashion (i.e., “between” versus “directly between”, “attached” versus “directly attached,” “adjacent” versus “directly adjacent”, etc.).

Terms such as “top,” “bottom,” “upper,” “lower,” “above,” “below,” and the like are used herein to describe the relationship of one element, layer or region to another element, layer or region as illustrated in the figures. It will be understood that these terms are intended to encompass different orientations of the device in addition to the orientation depicted in the figures.

It will be understood that, although the terms “first,” “second,” etc. may be used herein to describe various elements, these elements should not be limited by these terms. These terms are only used to distinguish one element from another. Thus, a first element could be termed a second element without departing from the teachings of the inventive concept.

It will also be appreciated that all example embodiments disclosed herein can be combined in any way.

Finally, it is to be noted that, the above-described embodiments are merely for understanding the present invention but not constitute a limit on the protection scope of the present invention. For those skilled in the art, modifications may be made on the basis of the above-described embodiments, and these modifications do not depart from the protection scope of the present invention.

1. A transmission unit for a phase shifter of a base station antenna, comprising:
a gear set;
a driving connecting rod configured to be coupled with a drive unit;
a controlling connecting rod configured to control the phase shifter; and
a scale connecting rod configured to be mounted with a scale;
wherein the driving connecting rod, the controlling connecting rod, and the scale connecting rod are respectively meshed with the gear set, and the controlling connecting rod is in transmission connection with the scale connecting rod through the gear set with a first transmission ratio less than 1.

2. The transmission unit for a phase shifter of a base station antenna according to claim 1, wherein the driving connecting rod and the controlling connecting rod are the same connecting rod, or the driving connecting rod and the controlling connecting rod are in transmission connection with the scale connecting rod through the gear set with a second transmission ratio greater than 1.

3. The transmission unit for a phase shifter of a base station antenna according to claim 2, wherein the second transmission ratio is at least 1.25.

4. The transmission unit for a phase shifter of a base station antenna according to claim 3, wherein the second transmission ratio is 2 to 3.

5. The transmission unit for a phase shifter of a base station antenna according to claim 2, wherein the second transmission ratio is a reciprocal of the first transmission ratio.

6. The transmission unit for a phase shifter of a base station antenna according to claim 1, wherein the reciprocal of the first transmission ratio is at least 1.25.

7. The transmission unit for a phase shifter of a base station antenna according to claim 6, wherein the reciprocal of the first transmission ratio is 2 to 3.

8. The transmission unit for a phase shifter of a base station antenna according to claim 1, wherein the driving connecting rod, the controlling connecting rod, and the scale connecting rod are guided in parallel to each other.

9. The transmission unit for a phase shifter of a base station antenna according to claim 1, wherein the gear set includes a first gear and a second gear, the first gear has a diameter smaller than that of the second gear, the controlling connecting rod is meshed with the first gear, and the scale connecting rod is meshed with the second gear.

10. The transmission unit for a phase shifter of a base station antenna according to claim 9, wherein the first gear and the second gear are coaxially and non-rotatably connected with each other.

11. The transmission unit for a phase shifter of a base station antenna according to claim 9, wherein the driving connecting rod is meshed with the second gear.

12. The transmission unit for a phase shifter of a base station antenna according to claim 10, wherein, with reference to a common axis of rotation of the first gear and the second gear, the driving connecting rod and the controlling connecting rod are on one side, and the scale connecting rod is on the other side.

13. The transmission unit for a phase shifter of a base station antenna according to claim 9, wherein the gear set further includes a first additional gear, the first additional gear has a diameter the same as that of the first gear, the first additional gear has an axis of rotation in parallel with and spaced apart from that of the first gear, the controlling connecting rod is further meshed with the first additional gear so that the controlling connecting rod is linearly guided by the first gear and the first additional gear.

14. The transmission unit for a phase shifter of a base station antenna according to claim 9, wherein the gear set further includes a second additional gear, the second additional gear has a diameter the same as that of the second gear, the second additional gear has an axis of rotation in parallel with and spaced apart from that of the first gear, the scale connecting rod is further meshed with the second additional gear so that the scale connecting rod is linearly guided by the second gear and the second additional gear.

15. The transmission unit for a phase shifter of a base station antenna according to claim 14, wherein the driving connecting rod is meshed with the second gear and the second additional gear so that the driving connecting rod is linearly guided by the second gear and the second additional gear.

16. The transmission unit for a phase shifter of a base station antenna according to claim 1, wherein the transmission unit includes a housing, and shafts of each gear of the gear set are supported in the housing.
